(19) United States
(12) Patent Application Publication
(10) Pub. No.: US 2002/0081914 A1
(43) Pub. Date: Jun. 27, 2002

(54) Terminal device of electric apparatus

(76) Inventors: Kouetsu Takaya, Saitama (JP); Yutaka Nakamura, Saitama (JP)

Correspondence Address: KANESAKA AND TAKEUCHI, 1423 Powhatan Street, Alexandria, VA, 22314, US

(21) Appl. No.: 10/013,958

(22) Filed: Dec. 13, 2001

(30) Foreign Application Priority Data
Dec. 22, 2000 (JP) 2000-390396

(51) Int. Cl. H01R 4/36

(52) U.S. Cl. 439/810

(57) ABSTRACT

A terminal device of an electric apparatus having a terminal board of a main circuit includes a hollow member connected to the terminal board of the main circuit of the apparatus. The hollow member is formed of an elongated metal plate having a screw hole, one end with a projection, and the other end with an engaging groove. The elongated metal plate is bent such that the projection and engaging groove are directly joined together to connect the one and the other end. A terminal screw is engaged with the screw hole of the hollow member.

### BACKGROUND OF THE INVENTION AND RELATED ART STATEMENT

The present invention relates to a wiring terminal device, which is connected to a terminal of an electric apparatus such as an electromagnetic contactor and a thermal relay attached to the electromagnetic contactor.

FIGS. 5(a) and 5(b) illustrate the above-mentioned electromagnetic contactor and thermal relay to which the present invention is applied. In these figures, a body case 3 for the electromagnetic contactor 1 and the thermal relay 2 is a resin-molded case. The body case 3 has wiring terminals 4 of a main circuit and a control circuit. The wiring terminals 4 are extended from the body of the apparatus to terminal portions 3a of a main and control circuit. Each terminal portion 3s is formed between interphase barriers.

A screw terminal corresponding to an electric wire (insulated coated wire) 6 having a compression terminal 5 is a standard equipment on the wiring terminal 4. If a strand 6a of the electric wire 6 is directly wired without using a compression terminal, a terminal device 7 is used as shown in FIGS. 6(a) and 6(b).

The terminal device 7 is connected to a terminal board 8 of the main circuit, which is extended to the terminal portion 3a, and is used to screw the strand 6a of the electric wire 6, inserted from the outside, between the terminal board 8 and a washer 11.

The terminal device 7 is comprised of a hollow member 9, a terminal screw 10 engaged on top of the member 9, and the washer 11 joined to the end of the terminal screw 10. As shown in the figures, to screw the strand 6a of the electric wire 6 inserted into the terminal portion 3a from the front, the strand 6a is pressed and screwed between the terminal board 8 and the washer 11 by screwing down the terminal screw 10. It should be noted that reference numeral 12 denotes a terminal cover that covers the terminal portion 3a to prevent electrification, an opening for inserting the electric wire 6 is formed in the front surface of the terminal cover 12, and an opening for operating the terminal screw 10 is formed in the upper surface of the terminal cover 12.

On the other hand, if the electric wire 6 is wired by using the terminal device 7, the clamp torque by screwing action is applied to the box 9 and the groove of the box 9 threading the terminal screw 10. Therefore, the member 9 needs to ensure such contour strength and thickness as to prevent deformation, and accordingly, the member 9 as a casting is used for the conventional terminal device 7.

The above-mentioned conventional terminal device 7, however, requires high cost due to a large scale casting equipment, and the conventional terminal device 7 cannot achieve enough accuracy.

It is therefore an object of the present invention to provide a new terminal device whose hollow member can easily be manufactured by using a series of press devices in a machining process by using a flat metal plate in order to reduce the cost and improve the dimensional accuracy.

### SUMMARY OF THE INVENTION

To accomplish the above object, the present invention provides in the first aspect a terminal device of an electric apparatus that is connected to a terminal board of a main circuit of an electric apparatus to screw a strand of an electric wire. The terminal device comprises a hollow member connected to the terminal board, a terminal screw engaged on top of the hollow member, and an electric wire pressing washer connected with an end of the terminal screw. The hollow member is constructed by bending an elongated metal plate in a form of a cylinder such that both ends thereof are directly joined together. The elongated metal plate may have a burred terminal screw hole, press-fitted engagement projections formed at one end thereof, and engagement grooves formed at the other end thereof. The engagement projections are fitted into the engagement grooves. By fitting together the engagement projections and the engagement grooves in directions perpendicular to each other in a state in which the metal plate is bent in the form of a cylinder while the terminal screw hole is positioned on top of the member. Preferred forms of the present invention will now be described.

(1) The two press-fitted engagement projections are stamped at both sides of one end of the metal plate, and the engagement grooves corresponding to the engagement projections are notched as U-shaped grooves at both sides of the other end of the metal plate (the second aspect).

(2) The two press-fitted engagement projections are formed in parallel at the center of an end of the metal plate, and the engagement grooves corresponding to the engagement projections are stamped as window holes in a surface of the other end of the metal plate (the third aspect).

(3) According to the above-mentioned paragraphs (1) and (2), the engagement projections and the engagement grooves are joined together and press-fitted in a state in which the engagement projections are fitted into the engagement grooves (the fourth aspect).

With the above described arrangement, the sequence of machining steps from the supply to assembly of the flat strip plate as material, i.e. a machining process comprising stamping, stamping and press-fitting, can be carried out by means of a series of press devices to thus manufacture the hollow member of the terminal device. Moreover, since the engagement projections and the engagement grooves formed at both ends of the elongated metal plate are fitted together perpendicularly to one another and press-fitted, and it is possible to ensure such a joint strength as to sufficiently withstand the clamp torque of the electric wire. Further, by burring the opening of the terminal screw hole, it is possible to form the screw groove having the same width as that of the thick plate.

### BRIEF DESCRIPTION OF THE DRAWINGS

FIG. 1(a) is a front view showing the construction of a terminal device according to a first embodiment of the present invention, and FIG. 1(b) is a side view thereof;

FIG. 2(a) is a plan view showing an extended condition of a member in FIG. 1, and FIG. 2(b) is a side view;

FIGS. 3(a)-3(d) are views in explaining a method of assembling the member in FIG. 1, wherein FIG. 3(a) is a perspective view showing the state in which engagement projections have not yet fitted into engagement grooves of an elongated metal plate, FIG. 3(b) is a view showing the way of press-fitting the joint, FIG. 3(c) is a view showing the press-fitted joint, and FIG. 3(d) is a sectional view taken along line 3(d)-3(d) in FIG. 3(c);

FIG. 4(a) is a plan view of an extended member according to a second embodiment of the present invention, FIG. 4(b) is a side view thereof, FIG. 4(c) is a perspective view showing the state in which engagement projections have not yet fitted into engagement grooves of an elongated metal plate, FIG. 4(d) is a view showing the way of press-fitting the joint, and FIG. 3(e) is a view showing the press-fitted joint;

FIGS. 5(a) and 5(b) are views showing the arrangement of an electric apparatus to which the present invention is applied, wherein FIG. 5(a) is an outside view showing an electromagnetic contactor, and FIG. 5(b) is an outside view showing a thermal overload relay attached thereto; and

FIG. 6(a) is a side sectional view showing the arrangement of a conventional terminal device for use in a terminal of the electric apparatus in FIGS. 5(a) and 5(b), and FIG. 6(b) is a front view thereof.

### DETAILED DESCRIPTION OF PREFERRED EMBODIMENTS

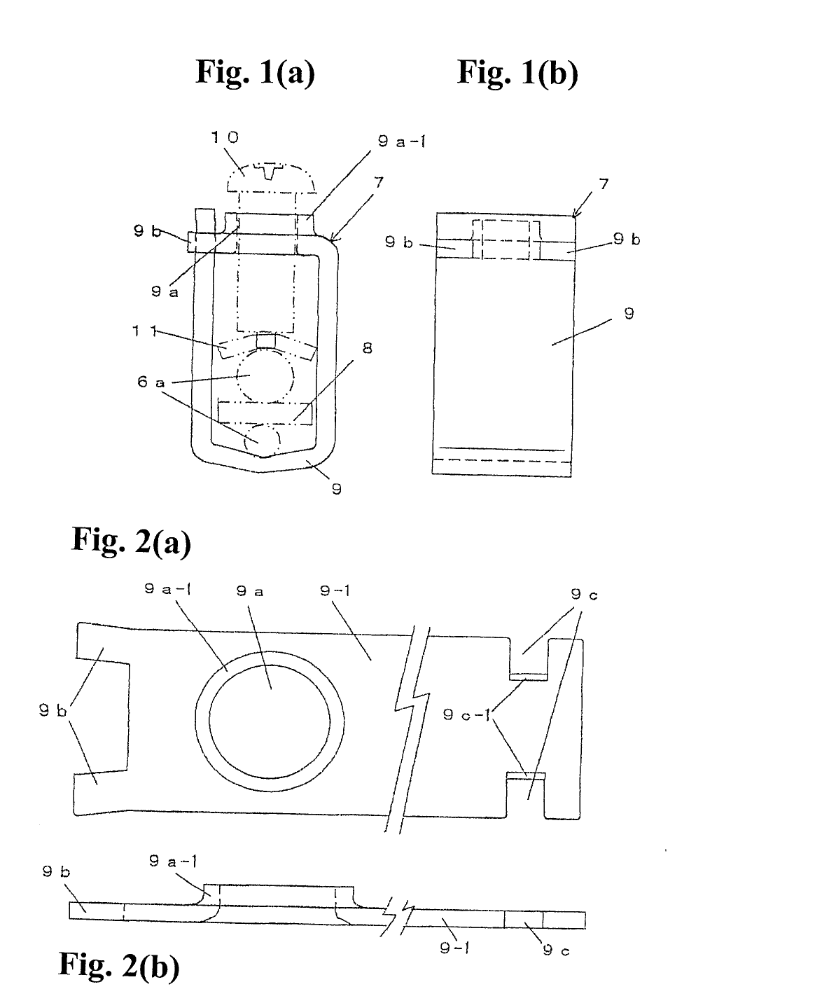

The present invention will now be described with reference to FIGS. 1-3 showing the first embodiment.

FIGS. 1(a) and 1(b) illustrate an embodiment corresponding to the first, second, and fourth aspects of the present invention. In the embodiment shown in these figures, a member 9 as a component of a terminal device 7 is constructed by bending an elongated metal plate 9-1 in FIG. 2, which is easy to press and bend, in the form of a cylinder, and then fitting engagement projections formed at one end of the metal plate 9-1 into engagement grooves formed at the other end at the corner of the member 9 as described below. The terminal device 7 is constructed by attaching a terminal screw 10 having a washer 11 to the member.

FIGS. 2(a) and 2(b) show an extended condition of the member 9. In the surface of the elongated metal plate 9-1 as a material for the member 9, a burred screw hole 9a is formed at a position corresponding to the center of the upper surface of the member 9 and a burred portion 9a-1 projects above from the periphery of the screw hole 9a. In parallel with the screw hole 9a, press-fitted engagement projections 9b are stamped at both sides of one end (left end) of the metal plate 9-1, and engagement grooves 9c, into which the press-fitted engagement projections 9b are fitted, are notched at both sides of the other end (right end) of the metal plate 9-1. It should be noted that the engagement projections 9a are formed to slightly project laterally as shown in FIG. 2(a), and the engagement grooves 9c are machined to form tapered surfaces 9c-1 at the bottom thereof so as to prevent the engagement projections 9b from coming off.

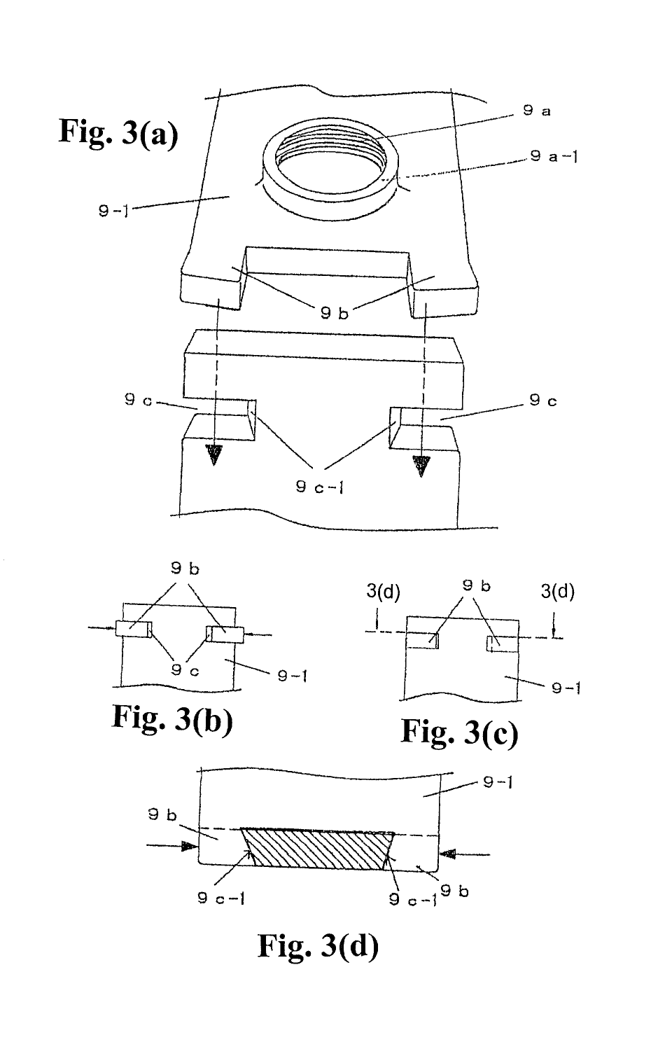

The metal plate 9-1, in which the screw hole 9a, the engagement projections 9b and the engagement grooves 9c are formed as described above, is then bent in the form of a square hollow member in a next plating step. On this occasion, the engagement projections 9b and the engagement grooves 9c formed at both ends of the metal plate 9-1, which intersect at the corner of the member 9 as shown in FIG. 3(a), are fitted to one another, and the engagement projections 9b are struck in a direction indicated by an arrow to be press-fitted in the engagement grooves 9c as shown in FIG. 3(b) to thus complete the member 9. It should be noted that FIGS. 3(c) and 3(d) show the engagement projections 9b that have been press-fitted, and as is clear from FIG. 3(d), the engagement projections 9b are tightly joined to the tapered surfaces 9c-1 of the engagement grooves 9c so as to prevent the engagement projections 9b from coming off. The formation of such tapered surfaces 9c-1 surely prevents the engagement projections 9b from coming off and improves the contour strength.

It should be noted that the above-described process comprising the step of supplying and cutting the elongated metal plate 9-1, the step of stamping the terminal screws 9a, the engagement projections 9b and the engagement grooves 9c, the step of bending the member 9, and the step of press-fitting can be carried out continuously by means of a series of press devices.

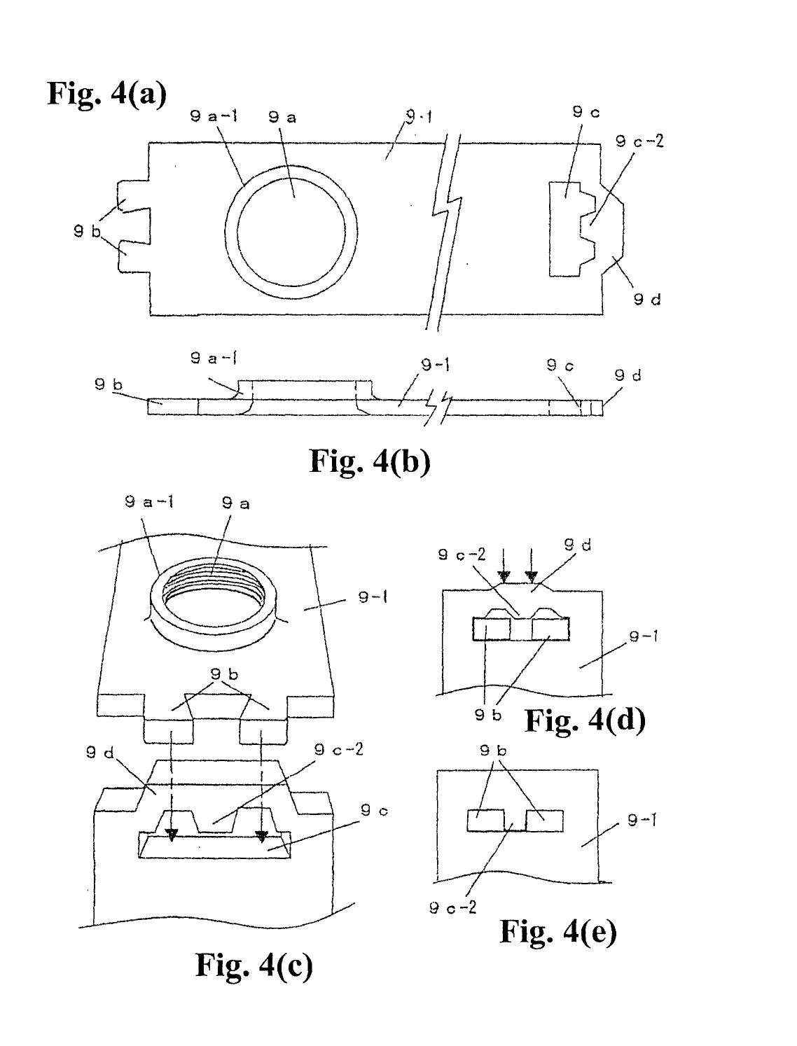

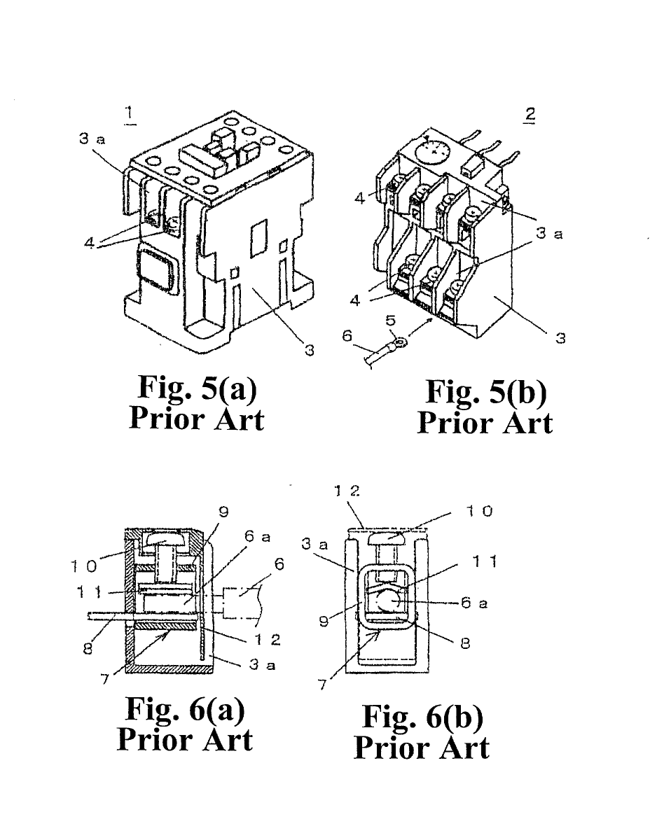

Referring next to FIGS. 4(a)-4(b), a description will be given of the second embodiment corresponding to the third aspect of the present invention. This embodiment is similar to the first embodiment in the construction of the assembled member 9 of the terminal device 7, but is different from the first embodiment in the shapes of the engagement projections 9b and the engagement grooves 9c formed at both ends of the elongated metal plate 9 and the way of caulking.

Specifically, the press-fitted engagement projections 9b are formed parallel at the center of one end (left side) of the elongated metal plate 9-1, and the projections 9b are shaped like a dovetail that is broader at its end than at its base. On the other hand, the engagement groove 9c formed at the other end (right side) of the metal plate 9-1 is stamped as a window hole broader in width than in length in the surface of the metal plate in such a manner as to correspond to both of the above-mentioned press-fitted engagement projections 9b. At the center of the edge of the window hole (at one side closer to the end of the metal plate 9-1), a wedge portion 9c-2 is formed toward the inside of the groove, and at the end of the metal plate 9-1, a convex portion 9d is formed at a position corresponding to the wedge portion 9c-2.

The metal plate 9-1 having the screw hole 9a, the engagement projections 9b and the engagement grooves 9c formed in the above-mentioned manner is bent in the form of a square hollow shape in a next plating step, and the press-fitted engagement projections 9b formed at one end of the metal plate 9-1 are fitted into the engagement groove 9c as the window hole opened in the surface perpendicular to the engagement projections 9b as shown in FIG. 4(c), and the end face of the metal plate 9-1 is struck in a direction indicated by an arrow in FIG. 4(d). Further, as shown in FIG. 4(e), the convex wedge portion 9c-2 of the engagement groove 9c is deformed and entered between the press-fitted engagement projections 9b, so that the engagement projections 9b are joined and press-fitted together. In this state, the dovetail-shaped engagement projections 9b are engaged with the wedge portion 9c-2, so that the engagement projections 9b and the engagement groove 9c are tightly joined together.

It should be noted that the above-described process comprising the step of supplying and cutting the elongated metal plate 9-1, the step of stamping the terminal screw hole 9a, the engagement projections 9b and the engagement groove 9c, the step of bending the member 9, and the step of press-fitting, is continuously carried out by means of a series of press die devices.

As set forth hereinabove, according to the present invention, the hollow member of the terminal device is constructed by bending the elongated metal plate such that both ends thereof are directly joined together. The elongated metal plate has the burred terminal screw hole, the press-fitted engagement projections formed at one end thereof, and the engagement groove formed at the other end thereof into which the engagement projections are fitted. In the state in which the metal plate is bent in the form of a hollow shape while the terminal screw hole is positioned on top of the hollow member, the engagement projections and the engagement groove are fitted together in the directions perpendicular to each other. This enables the sequence of machining steps to be carried out continuously by means of the simple series of press devices, and reduces the cost to a large extent and improves the dimensional accuracy of the member compared with the conventional casting.

Further, the fitted structure as stated in the second or third aspect makes it possible to ensure such an excellent joint strength as to withstand the clamp torque applied during wiring, and the press-fitted joint structure further improves the reliability.

While the invention has been explained with reference to the specific embodiments of the invention, the explanation is illustrative and the invention is limited only by the appended claims.

What is claimed is:

1. A terminal device of an electric apparatus having a terminal board of a main circuit, comprising:
a hollow member connected to the terminal board of the main circuit of the apparatus and formed of an elongated metal plate having a screw hole, one end with a projection and the other end with an engaging groove, said elongated metal plate being bent such that the projection and engaging groove are directly joined together to connect the one and the other end, and
a terminal screw engaged with the screw hole of said hollow member.

2. A terminal device of an electric apparatus according to claim 1, wherein said engagement groove formed at the other end includes two grooves, and said projection formed at the one end includes bifurcated engagement projections fitted in and engaging with the grooves, said bifurcated engagement projections and the grooves being arranged perpendicular to each other in a state that the metal plate is bent in a form of a hollow shape while the screw hole is positioned on top of the hollow member.

3. A terminal device of an electric apparatus according to claim 2, wherein said bifurcated engagement projections are formed to be spaced apart from each other at said one end of the metal plate, and the engagement grooves corresponding to the engagement projections are formed at two lateral sides at the other end of the metal plate.

4. A terminal device of an electric apparatus according to claim 2, wherein said bifurcated engagement projections have first tapered surfaces at portions facing each other, and said engagement grooves have second tapered surfaces at inner surfaces thereof to firmly engage the first tapered surfaces.

5. A terminal device of an electric apparatus according to claim 2, wherein said bifurcated engagement projections are arranged side by side at a center area of said one end of the metal plate, and said engagement grooves engaging the engagement projections are formed inside the metal plate as a window hole at the other end of the metal plate.

6. A terminal device of an electric apparatus according to claim 5, wherein said window hole has a wedge portion at one side thereof to be held between the bifurcated projections.

7. A terminal device of an electric apparatus according to claim 2, wherein the engagement projections and the engagement grooves are joined together to be press-fitted when the engagement projections are fitted in the engagement grooves.

8. A terminal device of an electric apparatus according to claim 1, further comprising an electric wire pressing washer connected with an end of said terminal screw, said terminal screw hole being a burred terminal screw hole.
